(19) United States
(12) Patent Application Publication
(10) Pub. No.: US 2007/0100684 A1
(43) Pub. Date: May 3, 2007

(54) Method of evaluating sales opportunities

(76) Inventor: Friedrich Gartner, Hillsborough, NC (US)

Correspondence Address: Friedrich Gartner, 5 Treadway Court, Hillsborough, NC, 27278, US

(21) Appl. No.: 11/262,608

(22) Filed: Oct. 31, 2005

(51) Int. Cl. G06F 17/30

(52) U.S. Cl. 705/10

(57) ABSTRACT

The present invention is directed to an Internet-based sales opportunity management tool designed to help sales managers organize input from their sales representatives into a consistent set of areas and determine which opportunities reflect the highest level of importance to the organization. Management can then make a judgment on the best way to utilize their sales force to take advantage of present or potential opportunities. The present invention is primarily concerned with translating sales data about an opportunity from a variety of sources into a comparable, quantitative number by utilizing inputs from multiple levels of a hierarchical sales force and weighting those inputs based on upper-level management's corporate decisions.

### BACKGROUND OF THE INVENTION

1. Field of the Invention

The present invention relates generally to evaluating opportunities and, more particularly, to evaluating sales opportunities by rating them with a software program.

2. Description of the Prior Art

Typically, organizations must evaluate opportunities, and in particular sales opportunities. They must determine which opportunities to pursue vigorously and which to place on the backburner. Upper-level management must determine what is important to the organization. However, the sales representatives that determine what constitutes an opportunity usually possess less information about the organizations overall business objectives than upper-level management does. Yet, it is the sales representatives that often are evaluating the sales opportunity.

These evaluations by the sales representatives alone are often solely subjective and may be skewed by the representatives' personal stake in the opportunity. The representatives' supervisor and other managers within the organization must sort through the evaluations and try to determine which ones the organization should pursue. This is inefficient and often out-of-line with the organizations business goals and objectives.

Thus, there remains a need for a method of evaluating opportunities efficiently and objectively in-line with the organizations business goals and objectives. In particular, there is a need to collect data about an opportunity from a sales force and organize that data into a common language, thereby allowing a management to compare, rate, and analyze strengths among the sales force's opportunities, and finally utilize those ratings to make key decisions for business opportunities. Further, the ratings should be quantitative to allow easy comparison by management.

### SUMMARY OF THE INVENTION

The present invention is directed to an Internet-based sales opportunity management tool designed to help sales managers organize input from their sales representatives into a consistent set of areas and determine which opportunities reflect the highest level of importance to the organization. Management can then make a judgment on the best way to utilize their sales force to take advantage of present or potential opportunities. The present invention is primarily concerned with translating sales data about an opportunity from a variety of sources into a comparable, quantitative number by utilizing inputs from multiple levels of a hierarchical sales force and weighting those inputs based on upper-level management's corporate decisions.

The present invention allows an organization to focus on the highest priority opportunities; it accomplishes this by generating a quantitative rating. The method uses weighted element category factors and indicated, rated, opportunity elements to determine the final rating for an opportunity. Importantly, the formula uses inputs from multiple levels of a sales hierarchy. Upper management of an organization starts by weighting the importance of various categories and the individual elements of those categories. Then, sales representatives determine the elements of their opportunities. Then, the present invention formulaically incorporates the elements, element ratings, and the weights formulaically to generate a final rating for the opportunity that the organization's management can use to evaluate many different opportunities.

Thus, the present invention provides a method of evaluating opportunities efficiently and objectively in-line with the organizations business goals and objectives.

Accordingly, one aspect of the present invention is to provide a method of rating an opportunity, including the following steps: providing an opportunity, wherein the opportunity comprises at least one element indicated from at least one element category, and wherein the at least one element is indicated by a first user; indicating a weighting factor for the at least one element category, wherein the weighting factor is indicated by at least one additional user; indicating an element rating for the at least one element, wherein the element rating is indicated by the at least one additional user; calculating at least one weighted element rating by multiplying the weighting factor by the element rating; and calculating an opportunity rating by summing the at least one weighted element rating of the elements comprising the opportunity, thereby rating the opportunity.

Another aspect of the present invention is to provide a method of rating an opportunity, including the following steps: providing a computer running software and a display, wherein the software displays a user interface capable of receiving input from a user and wherein the user interface displays and receives input for the following: indicating at least one element of an opportunity, wherein the at least one element is indicated from at least one element category; indicating a weighting factor for the at least one element category; and indicating an element rating for the at least one element. The software then creates an opportunity rating by calculating at least one weighted element rating by multiplying the weighting factor by the element rating; and then calculating an opportunity rating by summing the at least one weighted element rating of the elements comprising the opportunity, thereby rating the opportunity. Lastly, the software displays the opportunity rating on the display and/or in a report.

Still another aspect of the present invention is to provide A method of rating an opportunity for generating sales, including the following steps: providing a first opportunity and at least one additional opportunity, wherein each opportunity comprises at least one element indicated from at least one element category; indicating a weighting factor for the at least one element category; indicating an element rating for the at least one element; calculating at least one weighted element rating by multiplying the weighting factor by the element rating; calculating a first opportunity rating by summing the at least one weighted element rating of the elements comprising the first opportunity, thereby rating the first opportunity; calculating automatically at least one additional opportunity rating by summing the at least one weighted element rating of the elements comprising the at least one additional opportunity, thereby rating the at least one additional opportunity; and prioritizing the opportunities based on the opportunity ratings.

These and other aspects of the present invention will become apparent to those skilled in the art after a reading of the following description of the preferred embodiment when considered with the drawings.

### BRIEF DESCRIPTION OF THE DRAWINGS

FIG. 1 is a flow chart illustrating an overview of the method according to the present invention.

FIG. 2 is a screen view of a graphical user interface presenting inputs for the weighting factors according to the present invention.

FIG. 3 is a screen view of a graphical user interface presenting one set of elements and element ratings according to the present invention.

FIG. 4 is a screen view of a graphical user interface presenting inputs for adding or editing the element and element ratings of one element according to the present invention.

FIG. 5 is a screen view of a graphical user interface presenting another set of elements and element ratings according to the present invention.

FIG. 6 is a screen view of a graphical user interface presenting inputs for adding or editing the element and element ratings of another element according to the present invention.

FIG. 7 is a screen view of a graphical user interface presenting inputs for adding or editing the elements constituting an opportunity according to the present invention.

### DETAILED DESCRIPTION OF THE PREFERRED EMBODIMENTS

In the following description, like reference characters designate like or corresponding parts throughout the several views. Also in the following description, it is to be understood that such terms as “forward,” “rearward,” “front,” “back,” “right,” “left,” “upwardly,” “downwardly,” and the like are words of convenience and are not to be construed as limiting terms.

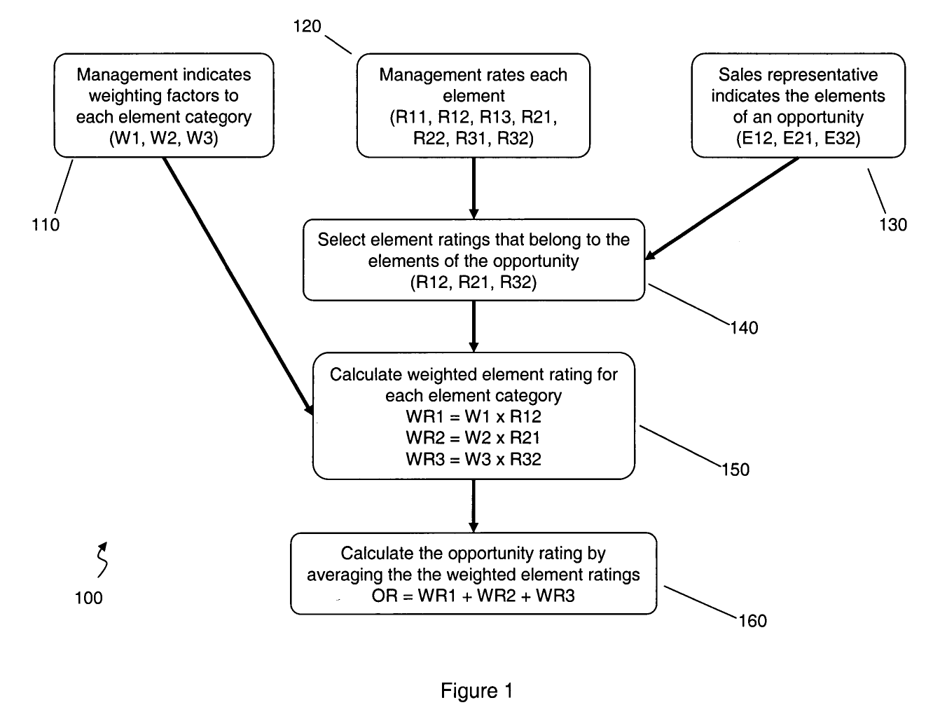

Referring now to the drawings in general, the illustrations are for the purpose of describing a preferred embodiment of the invention and are not intended to limit the invention thereto. As best seen in FIG. 1, is a flow chart 100 illustrating an overview of the method according to the present invention. Additionally, exemplary variables are given for purposes of discussion. The management of an organization begins by indicating weighting factors 110 for various element categories. For example, these weighting factors are represented by the variables W1, W2, and W3 corresponding to categories 1, 2, and 3, respectively. Next, management rates each element 120 on a scale. For example, the element ratings are represented by the variables R11, R12, R13, R21, R22, R31, and R32 (the first number following the “R” represents the element category, and the second number represents the element of that category—e.g. R12 is the element rating for the second element in the first category).

An opportunity is described here as a set of elements selected from the element categories. Sales representatives, after discovering an opportunity, indicate the elements of that opportunity 130. These elements may be represented by E12, E21, and E32, where, following the rationale of the element rating variables, E12 may represent the second element of the first category (e.g., the first category may be “product” and the second element of the product category may be “flamingoes”). Management's element ratings are then filtered to select the element ratings correlating to the selected elements of the opportunity 140. In the forgoing example, these selected element ratings would be R12, R21, and R32. Then, a weighted element rating is calculated for each category using the selected element ratings and the management's weighting factors 150. For instance, the weighted element ratings are WR1, WR2, and WR3; where WR1 equals W1 times R12, WR2 equals W2 times R21 and WR3=W3 times R32. Lastly, the final opportunity rating (OR) is calculated by summing the weighted element ratings 160. So, in the forgoing example, OR equals the sum of WR1, WR2, WR3.

Placing the numbers shown in Table 1 into the forgoing example, for purposes of discussion, would result in an opportunity rating of 3.2 in Table 1.

TABLE 1

| Weighting | Element | Weighted Element | Opportunity |
|---|---|---|---|
| Factors | Ratings | Ratings | Rating |
| W1 = 20% | R12 = 3 | WR1 = 0.2 × 3 = 0.6 | OR = 0.6 + 0.6 + 2 |
| W2 = 30% | R21 = 2 | WR2 = 0.3 × 2 = 0.6 | OR = 3.2 |
| W3 = 50% | R32 = 4 | WR3 = 0.5 × 4 = 2 | |

The opportunity rating number can be used to quantitatively compare the relative importance of various competing opportunities. Thus, it provides a quantitative rating for an opportunity to help an organization select the important business opportunities to pursue, as opposed to simply pursuing whatever business opportunities materialize regardless of the actual importance to the organization. An opportunity with an opportunity rating of 3.2 would be preferable than another with a rating of only 2.1. The present invention thus provides a comparative method for evaluating opportunities that objectively parallels the organization's business goals and objectives.

The forgoing discussion is merely exemplary, and many more weighting facts, element ratings, and elements may be utilized. For instance, the element categories preferably include customer, product lines, product families, products, channel, industry, market, market initiative, success probability, gross revenue, gross margin, and gross volume. Within each of those categories are user-defined sets of elements, preferably chosen by an organization's management. For example, the “customer” category can contain a list of customer names; and the “product” category can contain a list of product types (e.g. flamingoes, shoes, etc.).

Preferably, upper-level management establishes the weighting factor for each element category. This is based on management's grade of an opportunity and is determined by the quality and selection of the elements that make up the category. For instance, management can rank the “gross revenue” element category highest for cash flow reasons. Preferably, the weighting factors are percentages and cumulatively add to one-hundred percent. Additionally, management rates the importance of the elements within each element category. Alternatively, the sales force may rate the individual elements. Preferably, a sales force supervisor subjectively rates each element with input from the sales representatives, if the representatives do not accurately rate the elements themselves. The ratings are initially a subjective importance level: low, medium, high, very high, or critical. This qualitative rating is then translated to a numeric element rating of 1-5 (i.e. low=1, medium=2; high=3; very high=4; critical=5); this number is preferably an integer.

The sales representatives are preferably responsible for discovering and selecting the elements of an opportunity. For instance, they should identify an element for each element category (e.g. the products, industry, and product revenue) that belongs to that specific sales opportunity.

To summarize, the preferable method of the present invention functions with the senior management dictating the overall formula for rating on opportunity based on the weighting factors for the element categories and the element ratings assigned to each element. The inputs into the formula are selected by the sales representative when he or she selects the elements of the opportunity. For example, upper-level management decides the element categories that are going to be weighted and what weights categories will have (e.g. “Customer” is an element category that will carry 50% of the weight for the final rating). Also, management assigns, if possible, an element rating for all the possible elements of all opportunities (e.g. XYZ Corp. is a customer that rates as critical, or a “5”); this is done with the advice of others, for instance, the sales representatives. Then, the present invention incorporates the element categories and element ratings into a master formula that will produce the opportunity rating based on all the weighted element categories. This master formula changes infrequently, if at all, and is tied to the strategy of the company. Next, the sales representatives select only the elements of an opportunity; they have no direct mechanism to affect the rating of an individual element rating or weighting factor for an element category. That is, they do not determine if XYZ Corp. has a 1-5 element rating, or what weight the “Customer” element category will carry in the master formula. The representatives simply select the customer and the other elements of the opportunity.

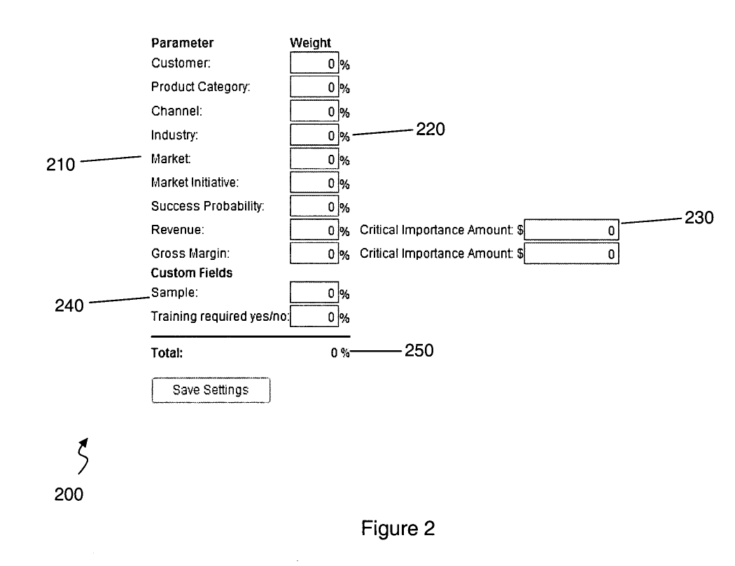

Preferably, the present invention is carried out by Internet-based software running on a computer with a display and appropriate input devices (mouse, keyboard, etc.). A screen view of a graphical user interface 200 presenting the weighting factor input dialogue is shown in FIG. 2. The multiple element categories 210 are shown in the left-most column. Shown here are some, but not all, of the possible element categories all may be included if desired. Additionally, custom fields 240 showing element categories not yet discussed may be added to the category list. Next to that column the input boxes 220 for the weighting factors of those element categories. Although the weighting factors 220 are all zero in FIG. 2, the software requires the user to indicate weighting factors that cumulatively add to 100 percent before the opportunity rating can be calculated. Further, management should indicate a critical importance amount 230 for each of gross revenue, gross margin, and gross volume; this is discussed below. When applied to a specific opportunity, gross revenue, margin, or volume is the sum of product revenue, margin, or volume, respectively for a particular opportunity.

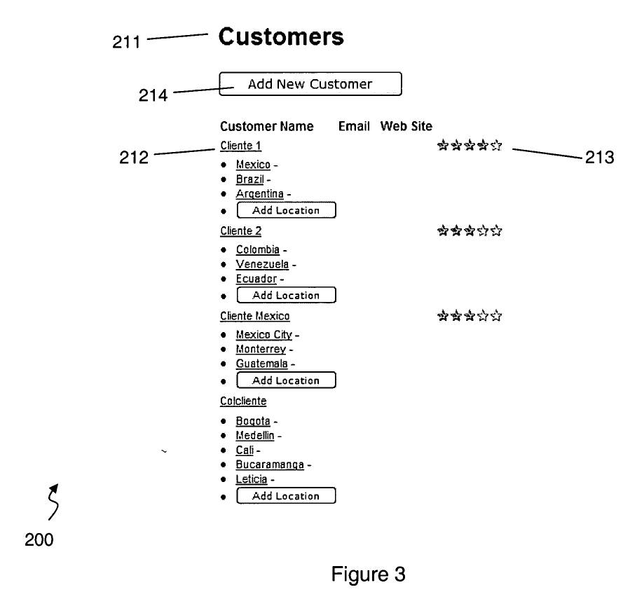

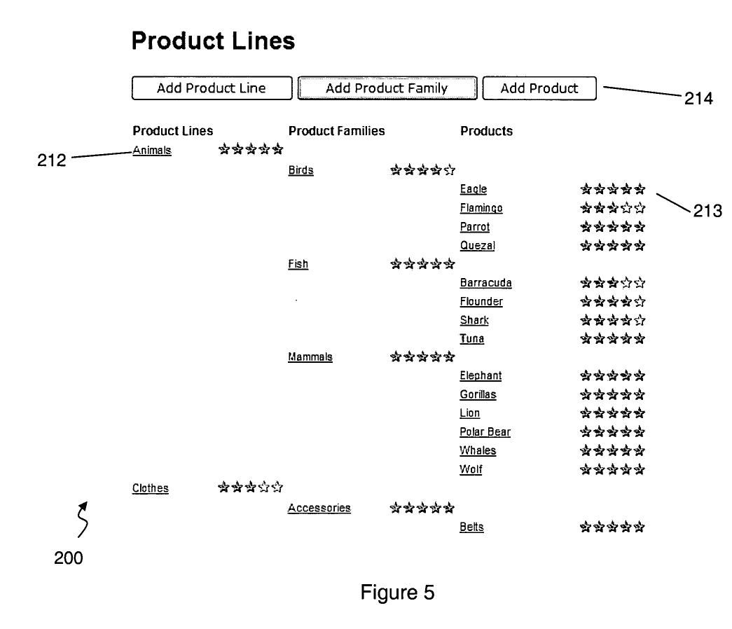

Examples of the elements within an element category are shown in the screen views of FIGS. 3 and 5. FIG. 3 is a graphical user interface presenting the elements 212 (customer names) within the element category 211 (customer category). Additionally, the element ratings 213 for each element 212 are displayed as stars in the right-most column. FIG. 5 likewise is a graphical user interface presenting the elements 212 (product lines, product families, and products) and their respective element ratings 213.

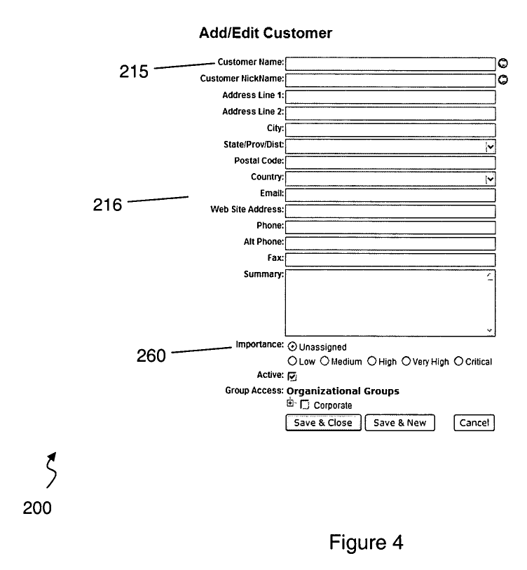

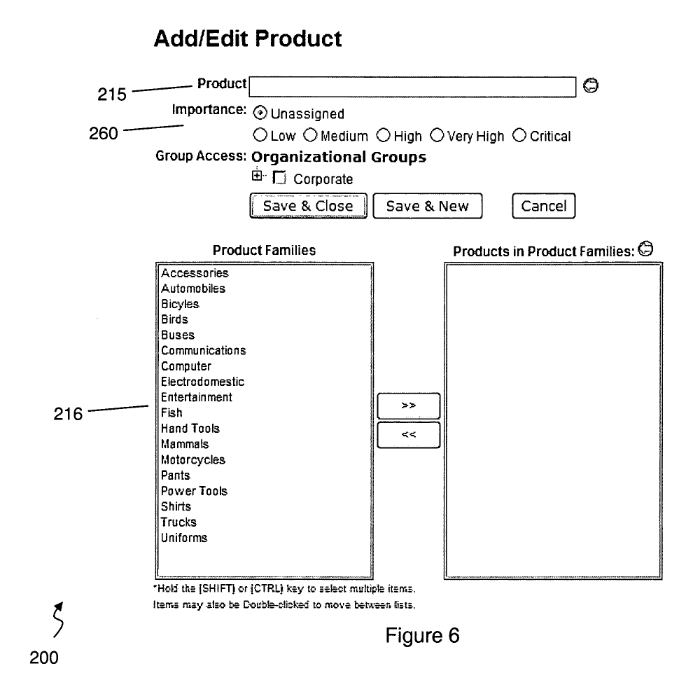

FIGS. 4 and 6 demonstrate the dialogue that is presented to a user after clicking on an add element button 214. FIG. 4 shows a screen view of a graphical user interface 200 presenting inputs for adding or editing the element and element ratings of the customer element. FIG. 6 likewise shows a screen view of a graphical user interface presenting inputs for adding or editing the element and element ratings of the product element according to the present invention. In these figures, identifying information for the element 215 can be indicated (customer name, product, etc.). Additional information 216 may also be associated with an element for use outside the present invention. Importantly, each element should have an importance-level 260 assigned. Again, this is one of the following: low, medium, high, very high, or critical and corresponds to an element rating of 1, 2, 3, 4, or 5, respectively. Further, an existing element can be similarly edited by clicking on an element's 212 name in the screen view of FIG. 3 or 5.

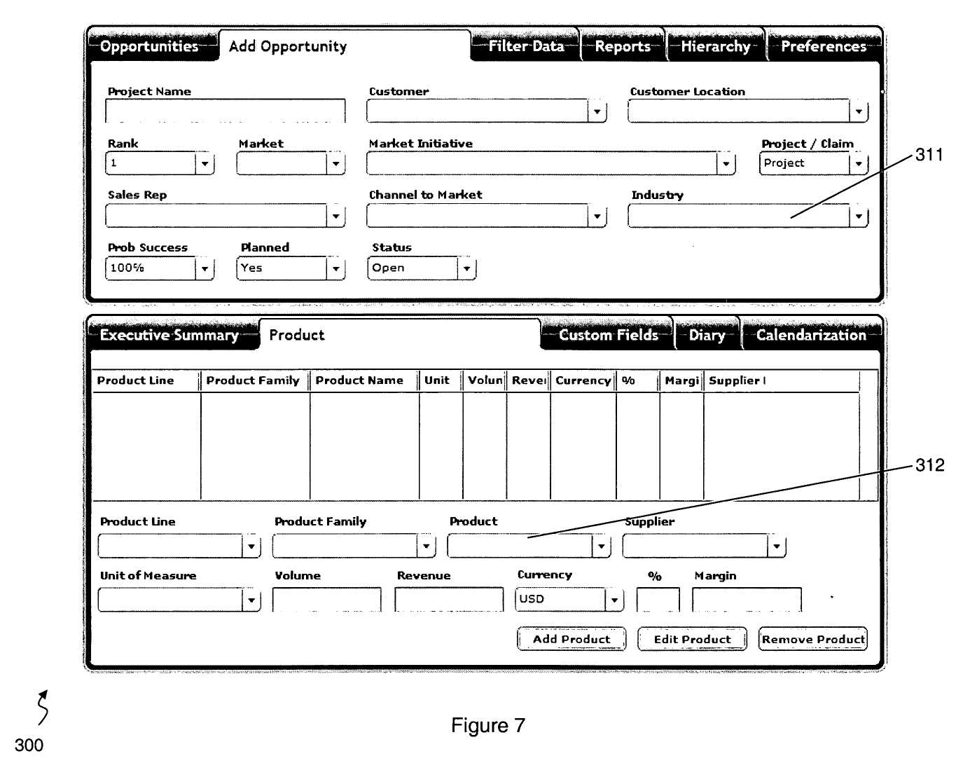

FIGS. 1-5 generally represent the graphical user interface and dialogues that the management of an organization, or the system administrator, acting on behalf of management, would utilize. FIG. 7 is a screen view of a graphical user interface presenting inputs for adding or editing the elements constituting an opportunity and is preferably used by a sales representative or other member of the sales force with working knowledge of the opportunity. In addition to entering the project name, the user selects/inputs the elements making up the opportunity, as selected from the various element categories. Various drop down buttons 311 provide for this functionality. Additionally, multiple products may be associated with an opportunity. Each product has its own set of buttons 312 to indicate its various constituting elements.

After the weighing factors, elements, and element ratings have been indicated and the opportunity has been identified and its elements selected or inputted, the opportunity may be rated as discussed above and laid out in the flow chart of FIG. 1. In some instances additional modifications are required to calculate the opportunity rating. First, all element ratings are pre-normalized to a maximum of five. Some elements may not have an element ratings (described as “unassigned”); in such cases, the element is not included in the weighting to prevent the inaccurate weighting of that element therefore, the remaining weighting factors are automatically adjusted such that the overall weighting factor percentages still add to 100 percent. Next, there may be many supplier, product, product line, and product family elements assigned to an opportunity. In these cases, the highest element ratings from each of the product, product line, and product family elements of the opportunity are used in calculating the opportunity ratings.

Then, Gross revenue, margin, and volume are normalized on a scale of zero to five based on the critical importance amount 230 from FIG. 2. This is accomplished by assigning a linear function to determine the element rating for gross revenue, margin, and volume. Therefore, gross revenue of $280,000 with a critical importance amount of $500,000 would yield an element rating of 2.8 for the gross revenue element. Therefore, the element rating for gross revenue, margin, and volume may be larger than five, if the dollar amount of the element is higher than the critical importance amount. This means that the opportunity rating could be larger than five; however, it is preferable for it to be between one and five.

After generating the opportunity rating, it can be used in the software program to show the user the opportunity rating; then that person can utilize that quantitative number to evaluate the opportunity as compared to other opportunities with similarly determined opportunity ratings. Lastly, each level of the sales hierarchy of an organization may have subjective, personalized ratings for an opportunity. These may be compared and contrasted to the present invention's opportunity rating and discussed at regular meetings between supervisor and subordinate so that all members of the sales force has a common understanding of which opportunities are important and why they are so.

Certain modifications and improvements will occur to those skilled in the art upon a reading of the foregoing description. By way of example, many other elements and element categories other than those discussed may be utilized to help an organization meet its goals and objectives. All modifications and improvements have been deleted herein for the sake of conciseness and readability but are properly within the scope of the following claims.

1. A method of rating an opportunity, comprising the following steps:
a. providing an opportunity, wherein the opportunity comprises at least one element indicated from at least one element category, and wherein the at least one element is indicated by a first user;
b. indicating a weighting factor for the at least one element category, wherein the weighting factor is indicated by at least one additional user;
c. indicating an element rating for the at least one element, wherein the element rating is indicated by the at least one additional user;
d. calculating at least one weighted element rating by multiplying the weighting factor by the element rating;
e. calculating an opportunity rating by summing the at least one weighted element rating of the elements comprising the opportunity, thereby rating the opportunity.

2. The method of claim 1, wherein the opportunity rating is used to prioritize the opportunity with respect to at least one additional opportunity by computing at least one additional opportunity rating for the at least one additional opportunity and comparing the opportunity rating with the at least one additional opportunity rating.

3. The method of claim 1, wherein the first user and the at least one additional user are members of a hierarchy within an organization.

4. The method of claim 3, wherein the first user is a sales representative and the at least one additional user is at least one manager of the organization.

5. The method of claim 1, wherein the at least one element category comprises multiple element categories and the weighting factor comprises multiple weighting factors for the multiple element categories.

6. The method of claim 5, wherein the multiple weighting factors are percentages that cumulatively sum to one-hundred percent and the element rating is an integer from one to five.

7. The method of claim 5, wherein the multiple element categories comprise customer, product line, product family, products, channel, industry, market, market initiative, success probability, revenue, margin, and volume; and wherein further, the element rating has a numeric range with a maximum number.

8. The method of claim 7, wherein the revenue, margin, and volume element categories comprise the elements of gross revenue, gross margin, and gross volume, respectively; and wherein the at least one element comprises at least one product element, and wherein further the at least one product element is associated with a product revenue, product margin, and product volume for the opportunity; and wherein the gross revenue, gross margin, and gross volume element ratings are determined by calculating the total product revenue, total product margin, and total product volume of the at least one product element of the opportunity and dividing the total product revenue, total product margin, and total product volume by a gross revenue critical importance amount, a gross margin critical importance amount, and a gross volume critical importance amount, respectively, to give a gross revenue percentage, a gross margin percentage, and a gross volume percentage, and then multiplying the gross revenue percentage, gross margin percentage, and gross volume percentage by the element rating range's maximum number to give a gross revenue element rating, a gross margin element rating, and a gross volume element rating, wherein the critical importance amounts are indicated by the at least one additional user.

9. A method of rating an opportunity, comprising the following steps:
a. providing a computer running software and a display, wherein the software displays a user interface capable of receiving input from a user and wherein the user interface displays and receives input for the following:
i. indicating at least one element of an opportunity, wherein the at least one element is indicated from at least one element category;
ii. indicating a weighting factor for the at least one element category;
iii. indicating an element rating for the at least one element;
b. creating an opportunity rating with the software, comprising the following steps:
i. calculating at least one weighted element rating by multiplying the weighting factor by the element rating;
ii. calculating an opportunity rating by summing the at least one weighted element rating of the elements comprising the opportunity, thereby rating the opportunity;
c. displaying the opportunity rating on the display.

10. The method of claim 9, wherein the software runs over a computer network.

11. The method of claim 9, wherein the opportunity rating is used to prioritize the opportunity with respect to at least one additional opportunity by computing at least one additional opportunity rating for the at least one additional opportunity and comparing the opportunity rating with the at least one additional opportunity rating.

12. The method of claim 9, wherein the at least one element is input by a first user and the weighting factor and the element rating are input by at least one additional user.

13. The method of claim 12, wherein the at least one additional user are members of a hierarchy within an organization.

14. The method of claim 13, wherein the first user is a sales representative and the at least one additional user is at least one manager of the organization.

15. The method of claim 9, wherein the at least one element category comprises multiple element categories and the weighting factor comprises multiple weighting factors for the multiple element categories.

16. The method of claim 15, wherein the multiple weighting factors are percentages that cumulatively sum to one-hundred percent and the element rating is an integer from one to five.

17. The method of claim 15, wherein the multiple element categories comprise customer, product line, product family, products, channel, industry, market, market initiative, success probability, revenue, margin, and volume; and wherein further, the element rating has a numeric range with a maximum number.

18. The method of claim 17, wherein the revenue, margin, and volume element categories comprise the elements of gross revenue, gross margin, and gross volume, respectively; and wherein the at least one element comprises at least one product element, and wherein further the at least one product element is associated with a product revenue, product margin, and product volume for the opportunity; and wherein the gross revenue, gross margin, and gross volume element ratings are determined by calculating the total product revenue, total product margin, and total product volume of the at least one product element of the opportunity and dividing the total product revenue, total product margin, and total product volume by a gross revenue critical importance amount, a gross margin critical importance amount, and a gross volume critical importance amount, respectively, to give a gross revenue percentage, a gross margin percentage, and a gross volume percentage, and then multiplying the gross revenue percentage, gross margin percentage, and gross volume percentage by the element rating range's maximum number to give a gross revenue element rating, a gross margin element rating, and a gross volume element rating, wherein the critical importance amounts are indicated by the at least one additional user.

19. A method of rating an opportunity for generating sales, comprising the following steps:
a. providing a first opportunity and at least one additional opportunity, wherein each opportunity comprises at least one element indicated from at least one element category;
b. indicating a weighting factor for the at least one element category;
c. indicating an element rating for the at least one element;
d. calculating at least one weighted element rating by multiplying the weighting factor by the element rating;
e. calculating a first opportunity rating by summing the at least one weighted element rating of the elements comprising the first opportunity, thereby rating the first opportunity;
f. calculating automatically at least one additional opportunity rating by summing the at least one weighted element rating of the elements comprising the at least one additional opportunity, thereby rating the at least one additional opportunity;
g. prioritizing the opportunities based on the opportunity ratings.
